(19) United States
(12) Patent Application Publication
(10) Pub. No.: US 2017/0311008 A1
(43) Pub. Date: Oct. 26, 2017

(54) PORTABLE MEDIA SERVER FOR PROVIDING OFFLINE PLAYBACK OF COPYRIGHT PROTECTED MEDIA

(71) Applicant: Shane Petersen, Eagle Mountain, UT (US)

(72) Inventor: Shane Petersen, Eagle Mountain, UT (US)

(21) Appl. No.: 15/496,226

(22) Filed: Apr. 25, 2017

Related U.S. Application Data
(60) Provisional application No. 62/327,285, filed on Apr. 25, 2016.

(51) Int. Cl. H04N 21/2387; H04N 21/61; H04N 21/472; H04N 21/258; H04N 21/254; H04N 21/232

(52) U.S. Cl. CPC H04N 21/2387; H04N 21/6175; H04N 21/6125; H04N 21/232; H04N 21/25816; H04N 21/2541; H04N 21/47217

(57) ABSTRACT

A portable media server for providing offline playback of copyright protected media includes a storage, a radio, an interface component, and a playback component. The storage is for storing one or more media content files for video playback. The radio is for providing a wireless network for communicating with one or more proximal client devices. The interface component is configured to receive a request for content (requested content) from a client device connected to the wireless network. The playback component is configured to stream the requested content to the client device via the wireless network for playback on the client device.

### CROSS-REFERENCE TO RELATED APPLICATIONS

This application claims the benefit under 35 U.S.C. §119(e) of U.S. Provisional Application No. 62/327,285, filed Apr. 25, 2016 with a docket number PSH-0001.PO, which is hereby incorporated by reference herein in its entirety.

### TECHNICAL FIELD

The present disclosure relates to systems, methods, and devices for a portable media server, and more particularly relates to providing portable access to media for client devices.

### BRIEF DESCRIPTION OF THE DRAWINGS

FIG. 1 is a schematic block diagram illustrating an operating environment for loading content onto a portable media server system, according to one embodiment.

FIG. 2 is a schematic block diagram illustrating a plurality of client devices and an audio/video device connected to the portable media server system, according to one embodiment.

FIG. 3 is a schematic flow chart diagram illustrating a method for connecting to and/or controlling a portable media server system, according to one embodiment.

FIG. 4 is a schematic call flow chart diagram illustrating example communication between the portable media server system and a client device to request content and provide content, according to one embodiment.

FIG. 5 is a schematic call flow diagram illustrating example communication between the portable media server system and a 3rd-party media service to load content onto the portable media server system, according to one embodiment.

FIG. 6 is a schematic block diagram illustrating components of a portable media server system, according to one embodiment.

FIG. 7 is a schematic flow chart diagram illustrating a method for offline content playback, according to one embodiment.

FIG. 8 illustrates a block diagram of an example computing device in accordance with the teachings and principles of the disclosure.

### DETAILED DESCRIPTION

Streaming of movies, audio, and other media from the Internet to Internet-enabled devices is becoming more and more common. Many Internet-based services allow users to stream media when an Internet connection is available. Example Internet-based streaming services include services provided by Netflix®, Vudu®, Amazon®, or the like. In some cases, users can download media to a device for viewing on that specific device when no Internet connection is available.

Portable storage media, such as portable hard drives, thumb drives, or the like, allow users to manually download and store files on the portable storage media. These are general purpose storage and, as such, the type of and purpose of the files stored is generally not limited and can be any digital file for any purpose. Some portable storage may be selectively connected (using a wired or wireless Interface) to one or more devices to allow those devices to access stored files.

Applicant has developed systems, methods, and devices which provide significant benefits, improvements, and functionalities which are currently not available. Applicants have recognized that systems, methods, and devices for providing portable access to media would benefit from copy protection. For example, portable storage media may allow connected devices to not only access media content, but also to make uncontrolled copies, causing potential copyright infringement concerns. Applicants have also recognized that a portable media system that can stream stored content to one or more client devices can provide more convenient operation than the copying then playback of whole files.

Applicants have also recognized that systems, methods, and devices for providing portable access to media would benefit from interfacing with existing streaming services. For example, portable media storage requires manual user interaction to copy and store files and do not connect to the Internet-based media services. The control interface for some portable media storage is through an application that works only with a specific product or storage and/or through a specific web URL when connected to the product.

According to one embodiment, a portable media server system interfaces with one or more Internet-based media content providers, local network media, or other media content providers to store media from one or more Internet-based media content providers, local network media, or other media content providers or content sources. In one embodiment, a portable media server system broadcasts a wireless signal that devices, such as smart phones, tablets, laptop computers, or other computing devices can connect to. In one embodiment, a number of connected devices may only be limited by a distance that a wireless signal can travel. Of course, radio or processing hardware and/or bandwidth limitations may also impose limitations on how many devices can be served by the portable media server system. In one embodiment, no explicit software or hardware limitation on the number of connected devices are imposed.

According to one embodiment, a user may control settings and/or content of a portable media server system using a client device (such as a smart phone, tablet, laptop computer, or other computing device). The client device may interface with the portable media server system using a web browser, an application installed on the client device (such as an application specific to an Internet-based streaming service or media content provider), or an application designed specifically for connecting to the portable media server system. In one embodiment, the portable media server system can be accessible through a wireless interface (such as a Wi-Fi, Bluetooth, or other interface) or wired interface (such as a wired local network connection to which the portable media server system is connected).

According to one embodiment, a portable media server system allows connected devices to view and listen to the stored media content stored locally on memory of the portable media server system using an internet web browser, an application installed on the device that corresponds to an Internet-based streaming service or content provider, or an application designed specifically for connecting to and playing content provided by the portable media server system. In one embodiment, the portable media server system offers copy protection by inhibiting a user's ability to copy or download the media files on the device.

In one embodiment, the portable media server system can be connected directly to a television, monitor, or other display or audio device to view and listen to the stored media. In one embodiment, the portable media server system may be controlled using a keyboard, mouse, touch-screen, or other human interface device. In one embodiment, the portable media server may be controlled using a connected client device through a wireless or wired local network connection. For example, a client device may be presented with a web page served by the portable media server that allows a user to change settings, download or delete content, or control playback of content.

According to one embodiment, the portable media server system interacts with apps designed for use with Internet-based media providers by spoofing a media providers' API and tricking the app into thinking it has reached a host Internet website. For example, even when the portable media server system does not have any Internet connection, the portable media server system may communicate with a client device using a web API that is expected by an application running on the client device. In one embodiment, the portable media server system may identify an API used by a client device (or application installed on the client device) and then provide content, an interface, or the like in accordance with the API used by the client device. Thus, a client device may use the same application used to access Internet-based streaming content, when connected to the Internet, as the client device uses to access content stored on the portable media server system when the client device and/or the portable media server system are not connected to the Internet. In one embodiment, the APIs or content providers supported by the portable media server system may be expanded through the installation of apps that enable the portable media server system to download, store, stream, and protect content in a way desired or designated by the content provider. For example, a 3rd party content provider may develop an app that runs on the portable media server system and that can authorize the download and storing of that content provider's copyrighted media content.

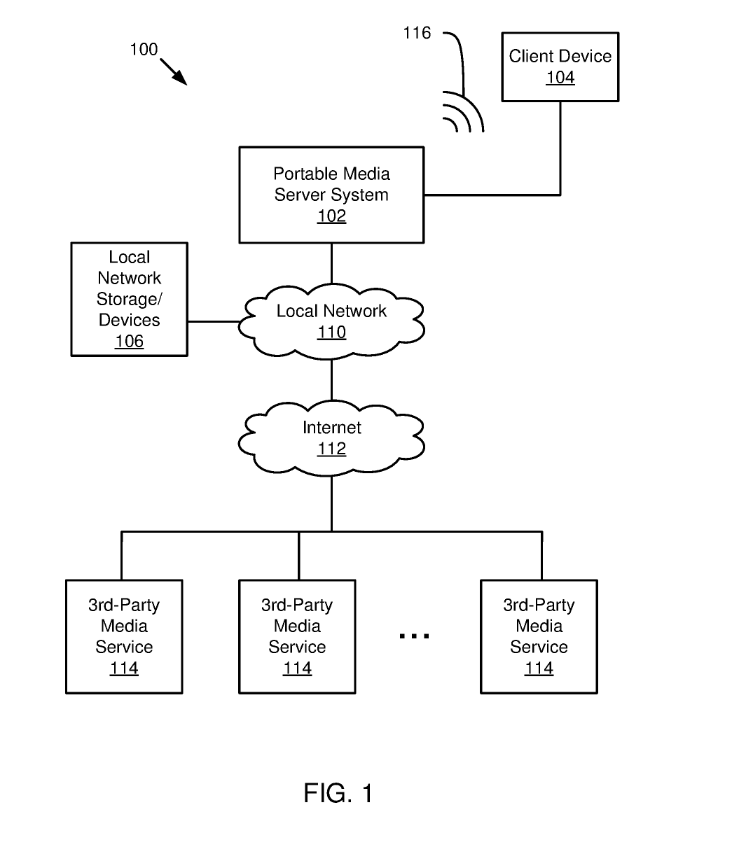

Turning to the figures, FIG. 1 is a schematic block diagram illustrating system 100 for loading content onto a portable media server system 102. The portable media server system 102 may include a computer, such as a single board computer, that is programmed or otherwise configured to store one or more media content files and allows users to access the media content files over a network interface whether or not an Internet connection is available or present. Users may use client device 104 to play the stored media over a network connection. The portable media server system 102 may disallow, using encryption or other copy or content protection scheme, downloading or copying of stored media to the client devices 104. In one embodiment, the copy or content protection scheme may be different for different content providers to allow content providers to use schemes they are comfortable with or that work well with Internet streaming or other existing content provider systems, applications, devices, or methods.

In one embodiment, the portable media server system 102 includes one or more processors, random access memory (RAM), data storage (such as internal storage media, external storage media, or both). The storage media may include any type of magnetic, solid state, or any other type of hard drive or storage media. The portable media server system 102 may include one or more USB input ports, display output ports or adapters, a built-in display with or without touch screen technology (such as a simple mono-color LCD display), built-in audio speakers, wireless network adapters, USB wireless network adapters, wired network adapters, internal battery for operation without a power source, external battery, a power button, a reset button, memory card slots, power ports, USB On-The-Go (OTG) ports, and/or USB power ports. An internal battery, removal battery, or port for plugging in a portable battery or power source may also be included to power the portable media server system 102 when it is not located near a power source. For example, battery power may be used during camping, flights, public transportation, or at any other time when a power source or cable is unavailable for powering the portable media server system 102.

In one embodiment, the portable media server system 102 may include components within a case or housing so that it is portable and capable of being moved from one location to another. Users may be able to connect the portable media server system 102 to the Internet, or other network, to load media onto the portable media server system 102. After the media is loaded, the portable media server system 102 may be turned on where there is no Internet available and user's client devices 104 may connect to it to play the stored media. In this scenario, the user's client devices 104 may connect to the wireless network provided by the portable media server system 102 to access the media stored by the portable media server system 102.

In one embodiment, the portable media server system 102 may also be installed or mounted to integrate with a vehicle and/or be integrated into a vehicle entertainment system of the vehicle, or in a home or business to be integrated with an entertainment system. For example, an in-dash computer or entertainment system may include software and/or hardware components as disclosed in relation to the portable media server system 102.

According to one embodiment, the portable media server system 102 specifically limits storage to specific types of files. For example, the portable media server system 102 may be designed or limited to media files such as, but not limited to, movies, music, and photos. In one embodiment, the portable media server system 102 does not allow normal file storage and transfer. For example, data loading or streaming of content may be limited to being transferred through secure APIs or protocols that check file types and/or credentials of devices that request to load data to, or transfer data from, storage of the portable media server system 102.

The portable media server system 102 may connect to a local network 110 or other networking node, when available, for loading of content. A local network 110 may include local area network (LAN) of a home, office, or public location. The local network 110 may provide access to the Internet 112. With a network connection, the portable media server system 102 may connect to and download content from a plurality of different devices. For example, the portable media server system 102 may connect to and download content from a local network storage or device 106. A local network storage or device 106 may include another computing or storage system attached to the local network 110 such as a network attached storage (NAS) system, server, desktop computer, laptop, or the like. As another example, the portable media server system 102 may connect to and download content from one or more 3rd party media services 114. Example 3rd party media services include Internet video streaming services such as those through Netflix®, Amazon®, Vudu®, and a variety of other video or streaming services. In one embodiment, for example, the portable media server system 102 may connect directly to a server of a 3rd party media service 114, authorize with that server using a user's credentials, and download one or more media content files for local storage as permitted by the 3rd party media service 114. In one embodiment, the portable media server system 102 may download content form a plurality of different sources and media services and store them for later offline playback. A client device 104 may control download/storage of media content via a web interface or other interface provided by the portable media server system 102.

The portable media server system 102 may include a radio that provides a wireless connection 116 (e.g., local wireless network) for connection to client devices 104 even when no other network or Internet service is available. For example, the portable media server system 102 may broadcast a local area network (e.g., Wi-Fi network) during a road trip where no Internet service is available, or where mobile data is expensive. One or more client devices 104 may then connect to the local area network to stream play video files stored by the portable media server system 102.

In one embodiment, the portable media server system 102 provides a web page or interface that shows a user or multiple users (via the client devices 104 or audio/visual device 206) the media content the user has access to through a 3rd party media service 114 and any local network media stored on a local network storage or device 106 on the local network 110 the portable media server system 102 is connected to. The portable media server system 102 may also show the user the media content that is already stored in local storage of the portable media server system 102.

Users of the client devices 104 and audio/video device 206 may have access to: delete media stored on the portable media server system 102; view (stream or consume) any media stored on the portable media server system 102; log in and out of accounts of 3rd party media services (e.g., for online streaming services); download local network media that is available from a network location to the portable media server system 102; download media that is available from 3rd party media services 114 (e.g., from Internet-based streaming services); and/or change settings for any accounts or for the portable media server system 102. The portable media server system 102 may also allow users to stream content directly to their client devices 104, while blocking or limiting opportunities for users to copy content files to other devices or memory. The portable media server system 102 may use blocks, encryption, rights management, or the like to ensure there is only one copy of each media file stored and no other copies can be made.

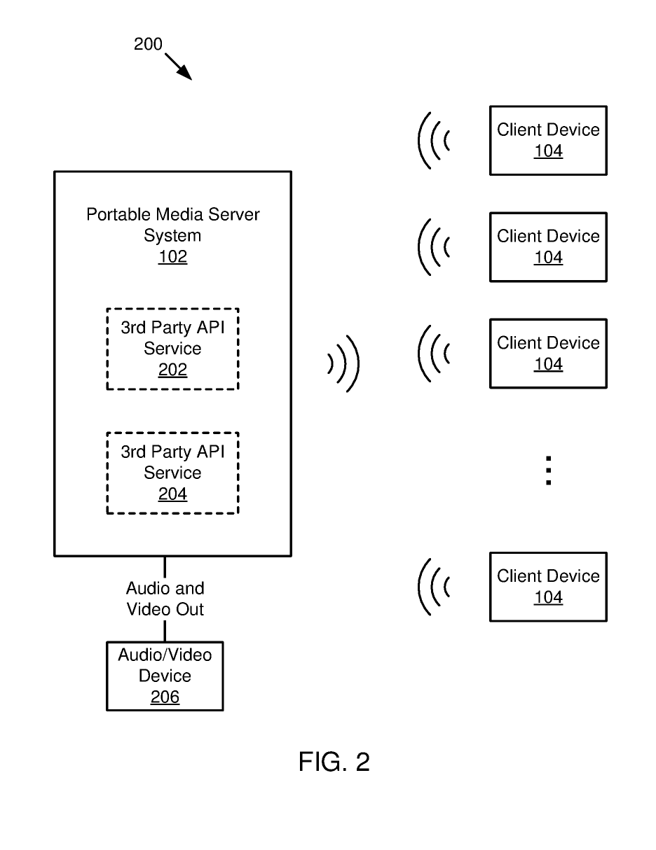

FIG. 2 is a schematic block diagram illustrating a playback system 200 including plurality of client devices 104 and an audio/video device 206 connected to the portable media server system 102. For example, the portable media server system 102 may simultaneously serve (using multi-tasking) one or more videos to the client devices 104 and audio/video device 206. For example, each of the client devices 104 and the audio/video device 206 may request and receive a different streaming video that is stored and/or streamed by the portable media server system 102. The client devices 104 and/or audio/video device 206 may connect using a wireless connection, wired connection, or output port. For example, the audio/video device 206 may be connected to an audio and video out port (such as an HDMI cable, a coaxial cable, component out cables, or any other audio or video out port). The audio/video device 206 may include a television, monitor, or other display screen. The audio/video device 206 may be a smart device that includes its own OS and that can make requests to the portable media server or may include a “dumb” display device that the portable media server system 102 provides an output signal to. The client devices 104 may use a web browser, 3rd party application, or application created specifically for integration with the portable media server system 102 to control content playback and playback content on their respective connection.

In one embodiment, when client devices 104 use a web browser to connect to or view content from the portable media server system 102, the portable media server system 102 will always serve its own internal web interface. For example, if a client device 104 requests any URL, even if it is not a URL for the internal web interface of the portable media server system 102, the portable media server system 102 will instead serve its own internal web interface for viewing and control the content of the portable media server system 102. The portable media server system 102 may block any request to view another website and may instead show its internal web interface. This may improve ease of operation and control of the portable media server system 102 using a client device 104.

According to one embodiment, the portable media server system 102 does not act as a wireless access point, internet/network bridge, or router for connected devices. For example, the portable media server system 102 may in no form, mode, or setup give Internet access to connected devices. Rather, connected devices (client devices 104 or audio/video devices 206) may only playback content from the portable media server system 102 or control operation of the portable media server system 102 via a connection with the portable media server system 102.

According to one embodiment, the portable media server system 102, integrates with 3rd-party applications installed on a client device 104 or audio/video device 206. For example, during serving of content to the client devices 104 or audio/video device 206 content may be provided in a format or manner expected by a specific mobile application, such as a 3rd party application installed on a client device 104 that include a mobile phone or tablet. The portable media server system 102 may integrate with a 3rd party applications using direct, approved integration through a partnership between a provider or manufacturer of the portable media server system 102 and the 3rd-party application developer. For example, the 3rd party may develop an application that works with an API of the portable media server system 102 and that implements an API to communicate with and provide playback using a 3rd party API. In one embodiment, the portable media server system 102 “spoofs” the 3rd-party application's API and only returns the stored media as a result to an API call by the 3rd-party application, thereby appearing to the 3rd-party application to be its correct API. In one embodiment, any API spoofing may be approved or authorized by the corresponding API owner or provider to address copyright, security, or other concerns. In one embodiment, a provider of the 3rd-party application may also provide an application which may be installed on the portable media server system 102 to correctly simulate or spoof the desired API. By operating according to the API for a 3rd-party application installed on the client devices 104 or audio/visual device 206, the client devices 104 or audio/video device 206 may operate as if they were connected to a website or server of the 3rd party. For example, a client device 104 with an application corresponding to an Internet-based streaming service of the 3rd-party may be able to stream content that has previously been downloaded and stored on the portable media server system 102 using the application corresponding to an Internet-based streaming service of the 3rd-party.

The portable media server system 102 is shown including two 3rd party API services 202 and 204. These 3rd party API services 202 and 204 may be initiated when a client device 104 or audio/video device 206 request content from a specific 3rd party content provider. For example, when the portable media server system 102 detects that a client device 104 is using a specific API, it may start a 3rd party API service to provide content to the client device in accordance with the specific API. The 3rd party API services 202 and 204 may represent virtual API services that are instantiated as needed to provide playback according to a desired API. For example, one client device 104 may use the 3rd party API service 202 while a different client device 104 uses the 3rd party API service 204. In one embodiment, code or specification for an API may be located within a 3rd party application installed on the portable media server system 102.

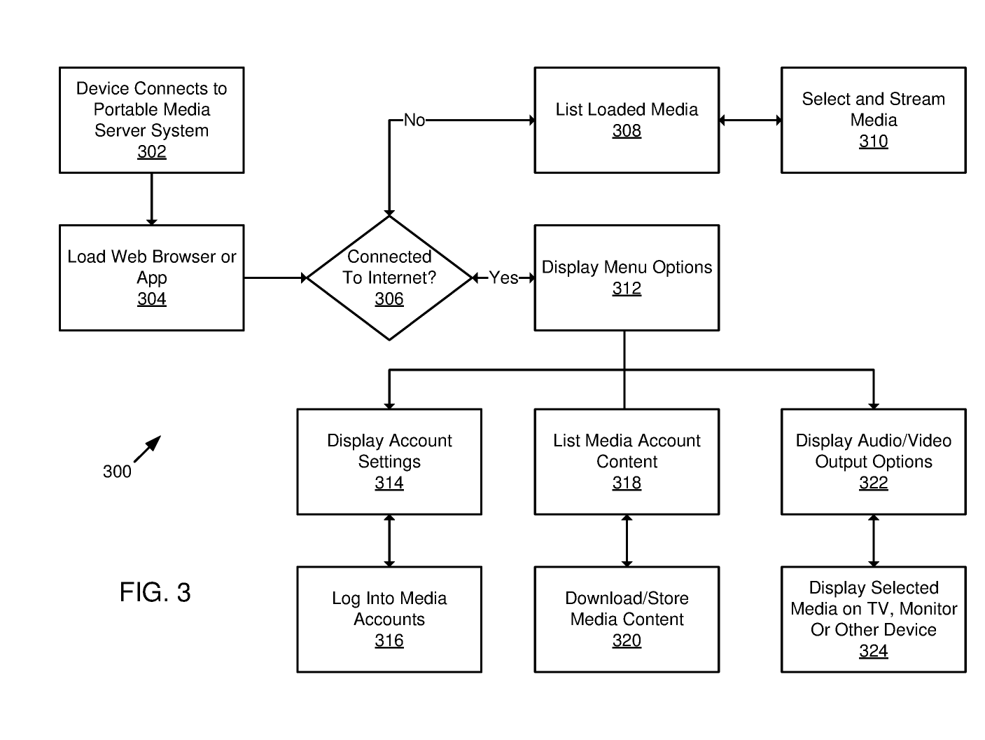

FIG. 3 is a schematic flow chart diagram illustrating a method for connecting to the portable media server system 102, accessing content on the portable media server system 102, loading content on the portable media server system 102, changing settings on the portable media server system 102, and/or deleting content on the portable media server system 102. Client devices 104 may connect 302 to the portable media server system 102 using a wireless connection provided by the portable media server system 102 (such as to a wireless network) or through a network or other interface connected to a wired port (network or other communication port) of the portable media server system 102.

When the client device 104 is connected to the portable media server system 102, the client device may load 304 a web browser or an application for streaming media content. After loading 304 of the browser or app by the client device 104, the portable media server system 102 may determine 306 whether the portable media server system 102 is connected to the Internet. If the portable media server system 102 is not connected to the Internet (No at 306), the portable media server system 102 may list 308 media that has been loaded and stored on the portable media server system 102. A user may provide input to a client device 104 and, based on the input, the client device 104 or portable media server system 102 may select 310 and stream media to the client device. This allows for offline playback within either a web browser or other app specific to a copyright owner or content provider of the stored media content.

If the portable media server system 102 is connected to the Internet (Yes at 306), the portable media server system 102 may display 312 menu options for management of the portable media server system 102 or content on the portable media server system 102. The menu options may include an account settings menu option, a load content option, and an output control option.

If the user provides input selecting the account settings menu option, the portable media server system 102 displays 314 account settings for the user and any accounts for content services that the user has. For example, the account settings may include options to add a new account corresponding to a local or online media content or streaming service. The user may be able to enter and save the authentication or login information to the portable media server system 102 so that the portable media server system 102 can access these accounts on the user's behalf. In one embodiment, a plurality of different account details can be entered and stored. Using the stored and entered account information, the portable media server system 102 may log 316 into media accounts for the user. For example, the account information may be used to login via a web interface or API provided by a 3rd party service via a network or the Internet.

If a user selects the option to load content, the portable media server system 102 lists 318 (through an interface provided to a client device 104) content that is available through the user's accounts. For example, the portable media server system 102 may list 318 media content that is available for download and storage on the portable media server system 102 using the account information entered by the user on an account settings screen. The user may select one or more content items and the portable media server system 102 downloads and stores 320 the selected content in storage on the portable media server system 102. The downloaded and stored content may not be available for offline playback on a user's client device 104. A user may also be able to see a list of downloaded content and select items to be deleted from storage on the portable media server system 102 to make room to download additional content.

If the user selects an option to control output of the portable media server system 102, the portable media server system 102 displays 322 (on a client device 104) options for outputting audio/video content on an attached device (such as a television or monitor that is coupled to a physical port on the portable media server system 102). For example, the user may select a specific output port and/or content to be provided to that output port. In one embodiment, the options to control output of the portable media server system 102 may be available when the portable media server system 102 is not connected to the Internet. If a user selects content to be output, the portable media server system 102 displays 324 the selected media on the connected device, such as a TV, monitor, or other device.

By using the method 300, a portable media server system 102 may allow users to see a list of the stored media; delete media from the device; download media from Internet content providers and store it on their device; view/play the stored media on their device across the network connection; and instruct the portable media server system 102 to play the stored media on a built-in display, or a television, monitor, or other audio/video device 206 that is connected to the audio/video output ports of the portable media server system 102 or is directly integrated with the portable media server system. Additionally, when a human input device (i.e., keyboard, mouse, touchscreen or other) is built into or connected to the portable media server system 102 using a USB or other input port, a user may directly control the portable media server system 102 to play media on a connected display device without the need to connect to the portable media server system 102 using a network.

Although FIG. 3 illustrates that displaying the menu items occurs if the portable media server system 102 is connected to the internet, the menu options may also be available if no Internet connection is available. Similarly, listing 308 loaded media may also be done when the portable media server system 102 is connected to the Internet. In one example embodiment, any of the following may be available whether or not an Internet connection is available: listing 308 loaded media; selecting 310 and streaming media; displaying 312 menu options; displaying 322 audio/video output options; and displaying 324 selected media on a TV, monitor, or another device. In one example embodiment, the following may only be available if there is an Internet connection: displaying 314 account settings; logging 316 into media accounts; listing 318 media account contents; and downloading/storing 320 media content.

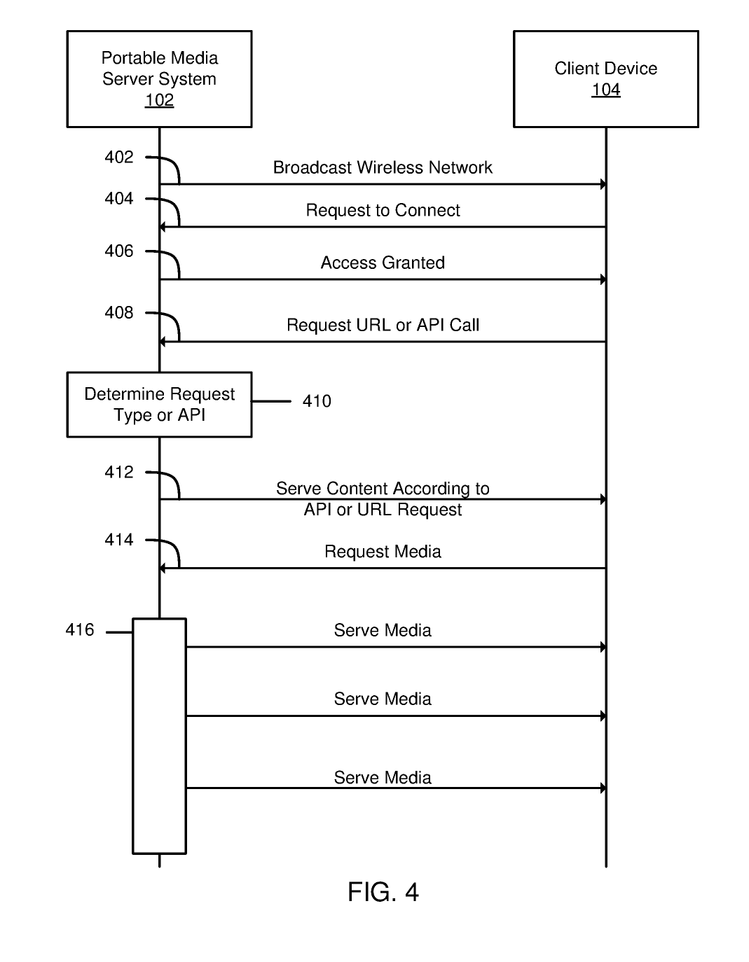

FIG. 4 is a schematic call flow diagram illustrating example communication between the portable media server system 102 and a client device 104 to request and initiate playback of content. For example, the communication in FIG. 4 may illustrate communication between the portable media server system 102 and a client device 104 when the portable media server system 102 is not connected to the Internet.

The portable media server system 102 broadcasts 402 details of a wireless network provided by the portable media server system 102. The client device 104 requests 404 to connect to the wireless network provided by the portable media server system 102. The portable media server system 102 grants 406 access to the client device 104 and a connection to the client device 104 is established. The client device 104 requests a URL or sends 408 an API call. The URL may be for any web address and the API call may be a request from a mobile app to view available content for streaming.

Based on the URL request or API call, the portable media server system 102 determines 410 a request type or API used by the client device 104. For example, the portable media server system 102 may determine that an application of a specific 3rd party content provider is being used. As another example, the portable media server system 102 may determine that a web browser is being used to view content on the portable media server system 102. The portable media server system 102 serves 412 content appropriate to the request or API call. For example, if the request included a URL, the portable media server system 102 may provide a web interface displaying available content stored in the portable media server system 102. As another example, if the request included an API call, the portable media server system 102 may send a response in accordance with the API. As one example, the portable media server system 102 may serve 412 a list of content available for the specific 3rd party application being used on the client device 104. The client device 104 requests 414 a media file or media content and the portable media server system 102 serves 416 (e.g., streams) the media file for viewing or consuming on the client device 104. For example, the request 414 may indicate a specific item of content that was listed as available by the portable media server system 102. The portable media server system 102 may serve 416 the media by providing chunks or packets over time to match or exceed playback on the client device 104. The content may be served 416 in accordance with an API and/or content protection scheme specific to the served content.

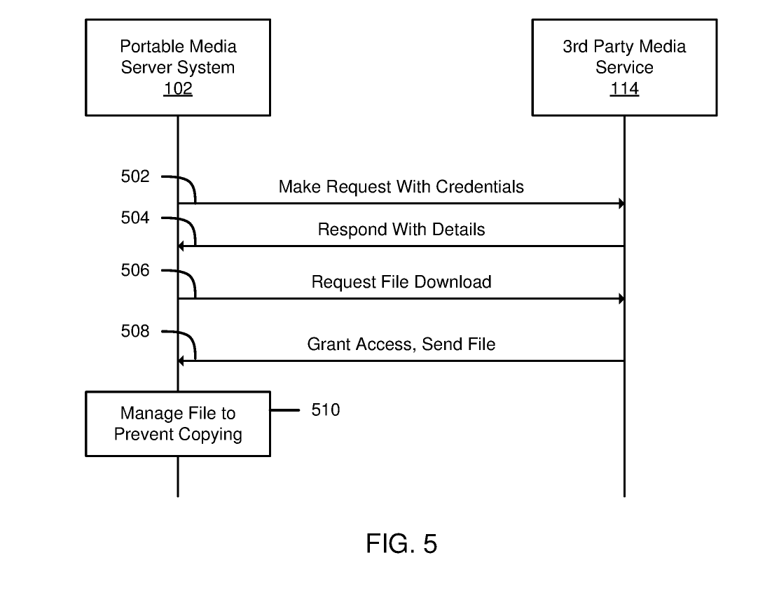

FIG. 5 is a schematic call flow diagram illustrating example communication between the portable media server system 102 and a 3rd-party media service 114 (which may include a server or computing system that provides media content via a network or the Internet) to load content onto the portable media server system 102. For example, the call flow may take place when the portable media server system 102 is connected to the Internet.

The portable media server system 102 makes a request 502 to the 3rd-party media service 114. The request may include a request 502 for a listing of available content for streaming or download. The request may include login or other authentication credentials to indicate that a user of the portable media server system 102 is a subscriber to the services provided by the 3rd-party media service 114 and/or authorized to download content. The 3rd-party media service 114 responds 504 to the portable media server system 102 with details about the 3rd-party media service 114. For example, the details may include information about available media content for viewing, streaming, or download. The portable media server system 102 requests 506 download of a media file (such as one within the details provided by the 3rd-party media service 114). For example, the portable media server system 102 may request 506 the file download in respond to a user making a selection or issuing a command from a portable media server system 102. The 3rd-party media service 114 grants 508 access and/or begins sending the requested media file for the portable media server system 102. The portable media server system 102 may store the file in local storage for offline playback or serving to a display or client devices 104. The portable media server system 102 manages 510 the file to prevent copying and allow streaming using allowed APIs or copyright protection schemes.

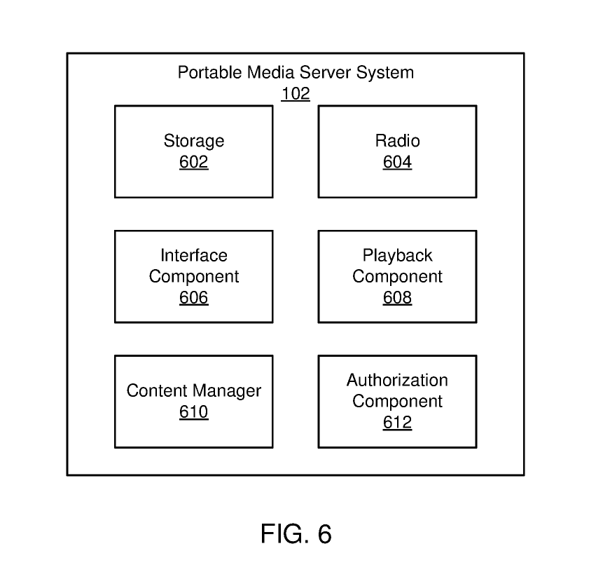

FIG. 6 is a schematic block diagram illustrating components of a portable media server system 102, according to one embodiment. The portable media server system 102 may provide for offline playback of copyright protected media. The portable media server system 102 includes a storage 602, radio 604, interface component 606, playback component 608, content manager, and authorization component 612. The components 602-612 are given by way of illustration only and may not all be included in all embodiments. In fact, some embodiments may include only one or any combination of two or more of the components 602-612. Some of the components 602-612 may be located outside or separate from the portable media server system 102, in some embodiments. Each of the components 602-612 may include hardware or media storing instructions for implementing the functionality, features, and structures discussed herein. In one embodiment, the portable media server system 102 is of small size to fit within a pocket or backpack. For example, the portable media server system 102 may be similar in size to a cell phone, portable hard drive, or the like.

The storage 602 is storage for storing one or more media content files for video playback. The storage may include any type of magnetic, solid state, or other storage media for storing large media files for offline playback.

The radio 604 includes an antenna, driving circuitry, and/or a controller for providing communication with a network or client devices. In one embodiment, the radio 604 provides a wireless network for communicating with one or more proximal client devices. In one embodiment, the radio 604 may allow for streaming or communication with up to four or five or more client devices 104 at a single time.

The interface component 606 is configured to provide a visual or programmatic interface for interacting with a client device 104 or a user of a client device 104. In one embodiment, the interface component 606 configured to receive a request for content (requested content) from a client device 104 connected to the wireless network. The interface component 606 may select an interface or API based on the received request or a source of the requested content. For example, the request may have an indication of the application or 3rd party content provider that the request corresponds to.

The interface component 606 is configured to provide an indication of available content to the client device based on an application program interface (API) corresponding to the content provider that provided the content. In one embodiment, the interface component 606 is configured to redirect web browser traffic of one or more client devices connected to the wireless network to an internally hosted web page for managing or viewing stored content on the portable media server. The interface component 606 may provide code or information about a visual interface to be displayed on a client device. The interface component 606 may include one or more physical ports for connecting to a client device or other output device via a cable.

In one embodiment, the interface component 606 may allow for playback of content to any available player or application on a client device 104. For example, a web browser or 3rd party application may be able to view a list or play any content stored on the portable media server system 102, unless a content provider provides a specific restriction. For example, one 3rd party content provider may require that all of their content may only be played through their own application that has been installed on a client device 104 and that has valid login credentials or a certificate proving authorization. Thus, content that does not have restrictions placed on it may be played on various apps to improve ease of use.

The playback component 608 is configured to provide for playback of content stored on the storage 602 on a client device 104. For example, the playback component 608 may stream requested content directly to a client device 104 via a wireless connection. In one embodiment, the playback component 608 only streams the requested content in response to the authorization component 612 determining that the client device 104 is authorized. The playback component 608 may also only stream the requested content using the selected interface or API determined by the interface component 606 if the interface or API is approved by a 3rd party content provider. The playback component 608 may also display content on a playback device (such an audio/video device) via a physical connection.

The content manager 610 is configured to manage content stored on the portable media server system 102. In one embodiment, the content manager 610 loads content into the storage 602. The content manager 610 may load the content by connecting to a remote Internet content provider, authenticating with the remote Internet content provider, and downloading and storing content from the remote Internet content provider. The content provider 610 may store the content in accordance with a copyright protection scheme approved or provided by the remote Internet content provider. The copyright protection scheme may be reflected in instructions within a 3rd party app installed (e.g., an app developed or approved by the remote Internet content provider) on the portable media server system 102 or may include instructions indicated when downloading the content from the remote Internet content provider. In one embodiment, the content manager 610 restricts or prohibits copying of files from the storage to another device or storage location. For example, the files or content may be encrypted and may not be accessed for copying. Playback of content may only be allowed in a manner that protects copyright, such as by streaming using an approved API or application.

The authorization component 612 determines whether a client device 104, API, or application is authorized to receive the requested content. In one embodiment, the authorization component 612 processes or compares a certificate of the client device 104 or application to determine whether it is authorized to playback content from a specific content provider. In one embodiment, the authorization component 612 may compare the details for a requesting client device 104 or application with details indicating approved client devices or applications that are permitted to playback the content.

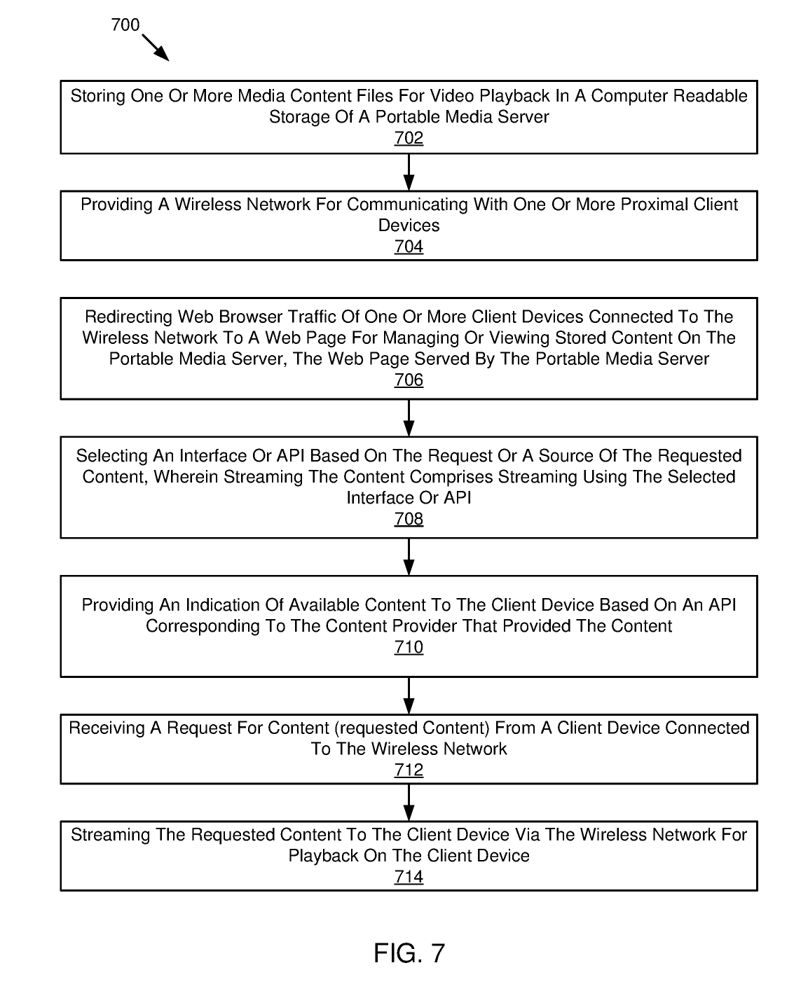

FIG. 7 is a schematic flow chart diagram of a method 700 for providing offline playback of media content, according to one embodiment. The method 700 may be performed by a portable media server system, such as the portable media server system 102 of FIG. 1 or 2.

The method 700 begins and a portable media server system 102 stores 702 one or more media content files for video playback in a computer readable storage of a portable media server. The portable media server system 102 provides 704 a wireless network for communicating with one or more proximal client devices. The portable media server system 102 redirects 706 web browser traffic of one or more client devices connected to the wireless network to a web page for managing or viewing stored content on the portable media server, the web page served by the portable media server.

The portable media server system 102 selects 708 an interface or API based on the request or a source of the requested content, wherein streaming the content comprises streaming using the selected interface or API. The portable media server system 102 provides 710 an indication of available content to the client device based on an API corresponding to the content provider that provided the content. The portable media server system 102 receives 712 a request for content (requested content) from a client device connected to the wireless network. The portable media server system 102 streams 714 the requested content to the client device via the wireless network for playback on the client device.

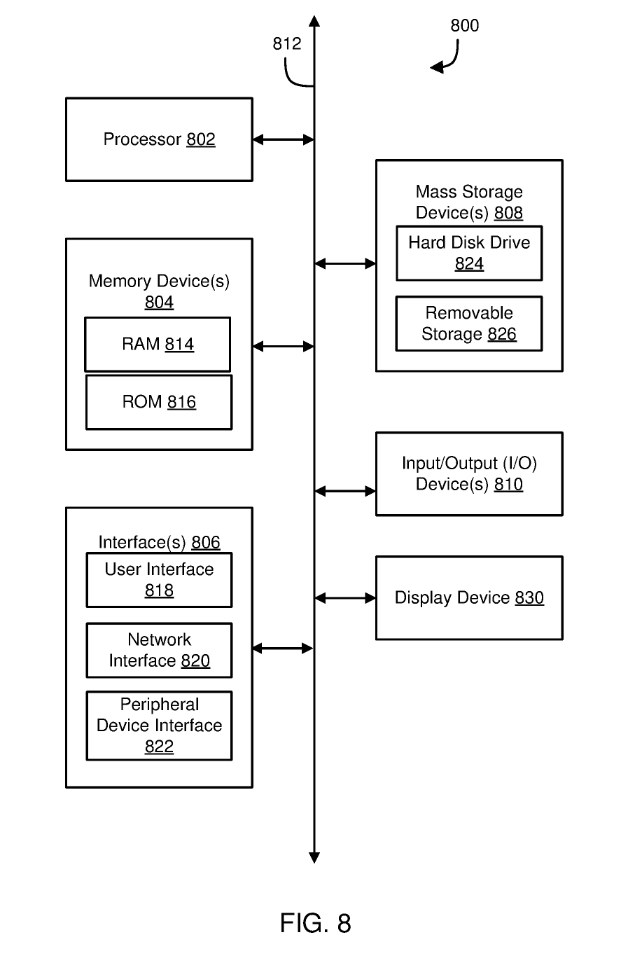

Referring now to FIG. 8, a block diagram of an example computing device 800 is illustrated. Computing device 800 may be used to perform various procedures, such as those discussed herein. Computing device 800 can function as a server, a client, or any other computing entity. Computing device 800 can perform various monitoring functions as discussed herein, and can execute one or more application programs, such as the application programs described herein. Computing device 800 can be any of a wide variety of computing devices, such as a desktop computer, a notebook computer, a server computer, a handheld computer, tablet computer, ultra-portable computer, smartphone, embedded system, and the like.

Computing device 800 includes one or more processor(s) 802, one or more memory device(s) 804, one or more interface(s) 806, one or more mass storage device(s) 808, one or more Input/Output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM) 814) and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid-state memory (e.g., Flash memory), and so forth. As shown in FIG. 8, a particular mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 may include any number of different network interfaces 820, such as interfaces to local area networks (LANs), wide area networks (WANs), wireless networks, and the Internet. Other interface(s) include user interface 818 and peripheral device interface 822. The interface(s) 806 may also include one or more user interface elements 818. The interface(s) 806 may also include one or more peripheral interfaces such as interfaces for printers, pointing devices (mice, track pad, or any suitable user interface now known to those of ordinary skill in the field, or later discovered), keyboards, and the like.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1364 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### Example Embodiment

The following discussion pertains to an example embodiment.

In one embodiment, a portable media server is designed to protect the copyrights of the content it stores. Where competing products allow easy copying and redistribution of content, the portable media server restricts users to streaming only. Copying and downloading is specifically blocked. The portable media server protects copyright in two ways: blocking redistribution and honoring partner content restrictions.

The portable media server blocks redistribution by not allowing users or devices to copy content from the portable media server device to a client device. It actively attempts to block all download/copy requests, while only allowing content to be streamed. This means that when the portable media server downloads a copy of a movie, it retains only one copy and never allows another copy to be created. After users are done with the content on the portable media server, they can delete it, destroying the only copy made.

The portable media server honors partner content restrictions by working with content providers to place further copyright protecting restrictions on movies. This includes: encrypting the downloaded content to only allow authorized users/accounts to view the content; and setting expiration dates for content. When content is downloaded from content providers, the content can be set to expire after a requested period of time. After that period, the portable media server deletes or locks the content, depending on the content provider's requirements.

The portable media server allows plugins (apps) to be installed to extend functionality. The portable media server by itself only serves and protects content, in one embodiment. It requires plugins to be added to give it access to content providers to download/load new content. The portable media server allows providers to create plugins that allow their content to be available to users. These plugins control users accounts with the content providers, access to content, download restrictions and copyright protection requirements. In one embodiment, the portable media server currently includes 3 plugins: a USB plugin, a Sagebin® plugin, and Plex® plugin. The USB plugin allows users to plug in a USB storage device and copy movies to the portable media server. As USB is not a content provider, it has no content restrictions, but the portable media server still blocks users from copying/downloading copies of USB-loaded content.

The Sagebin® plugin connects to sagebin.com, shows people the movies that are in their account and allows them to download that content for up to 14 days in a “checkout process”. After the restricted time period is reached, the Sagebin® content is “locked”, not allowing users to play/stream/view that content until they have connected the portable media server to the internet and recheckout the content for another 14-day period.

The Plex® plugin allows the portable media server to download and playback Plex content. Plex is a home media server. Through this plugin, the portable media server can search the connected network for Plex servers, allow users to log into their accounts and then view the content they have access to on their local Plex server. Plex is not a content provider, so it's restrictions are the same as USB.

The portable media server integrates directly with content providers. Unlike existing system, the portable media server connects directly to content providers via their plugins. This means the portable media server downloads content directly from a content provider (i.e. Sagebin) without needing to go through another 3rd party device (phone, computer, etc). The portable media server only requires instruction from a client device to tell it what to download. Users may be able to use the portable media server's website (and possibly content provider websites) to load the portable media server remotely.

The portable media server can be used to watch content directly, in one embodiment. The portable media server can be plugged into a TV and stored content can be played directly from the device to the TV. This allows users to use the device as the player itself, in addition to using it with client devices to stream content. A human interface device (keyboard, mouse) may be plugged in to a USB port to control the device and make content selections.

In one embodiment, an Internet website shows a user all of their portable media server devices and what content is on those devices. It shows when things expire and what will be deleted/locked when it expires. From the internet page, users can queue items for deletion, renewal or download. Then, all they need to do is plug the portable media server into an internet connection and then it will check the queue created for it and perform the tasks of deleting, renewing and downloading content.

The portable media server may automatically sync content when an Internet connection is present. When it is connected to the Internet, the portable media server periodically checks for updates to its configuration or to available downloadable media. When present, it would check to see if there are requested changes and then would follow the instructions set by the portable media server or the 3rd party content provider. The portable media server may automatically connect to the Internet using a wired or wireless connection. That means if the portable media server were in your car, as soon as you pull in your driveway it would find your home WiFi, connect and automatically sync. You would never need to remove it from the car again.

The portable media server may be built into vehicles in place of or paired with their current entertainment systems. The portable media server may be the entertainment system for the car and would get its content from your home WiFi when you are at home.

Various techniques, or certain aspects or portions thereof, may take the form of program code (i.e., instructions) embodied in tangible media, such as floppy diskettes, CD-ROMs, hard drives, a non-transitory computer readable storage medium, or any other machine readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, include one or more physical or logical blocks of computer instructions, which may, for instance, be organized as an object, a procedure, or a function. Nevertheless, the executables of an identified component need not be physically located together, but may include disparate instructions stored in different locations that, when joined logically together, include the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

1. A portable media server for providing offline playback of copyright protected media, the server comprising:
storage for storing one or more media content files for video playback;
a radio for providing a wireless network for communicating with one or more proximal client devices; and
an interface component configured to receive a request for content (requested content) from a client device connected to the wireless network; and
a playback component configured to stream the requested content to the client device via the wireless network for playback on the client device.

2. The portable media server of claim 1, wherein the interface component is further configured to provide an indication of available content to the client device based on an application program interface (API) corresponding to the content provider that provided the content.

3. The portable media server of claim 1, wherein the client device comprises a first client device and the requested content comprise first requested content, wherein the portable media server connects over the wireless network to a plurality of client devices comprising the first client device and a second client device, wherein:
the interface component is configured to receive a request for second content (second requested content) different than the first requested content from the second client device connected to the wireless network; and
the playback component is configured to stream the second requested content to the second client device via the wireless network for playback on the second client device.

4. The portable media server of claim 1, wherein the interface component is configured to redirect web browser traffic of one or more client devices connected to the wireless network to a web page for managing or viewing stored content on the portable media server, the web page served by the portable media server.

5. The portable media server of claim 1, further comprising an authorization component configured to determine whether the client device is authorized to receive the requested content, wherein the playback component is configured to stream the requested content in response to the authorization component determining that the client device is authorized.

6. The portable media server of claim 1, wherein the interface component selects an interface or API based on the request or a source of the requested content, wherein the playback component streams the content using the selected interface or API.

7. The portable media server of claim 1, further comprising a content manager configured to load content into the storage, wherein the content manager is configured to:
connect to a remote Internet content provider;
authenticate with the remote Internet content provider; and
download and store content from the remote Internet content provider;
wherein the content manager restricts or prohibits copying of files from the storage to another device or storage location.

8. The portable media server of claim 14, wherein the content manager is configured to download and store the content from the remote Internet content provider based on restrictions provided by the remote Internet content provider.

9. The portable media server of claim 1, wherein the interface component is further configured to display content on a playback device via a physical connection with a playback device comprising a video screen.

10. A computer implemented method comprising:
storing one or more media content files for video playback in a computer readable storage of a portable media server;
providing a wireless network for communicating with one or more proximal client devices;
receiving a request for content (requested content) from a client device connected to the wireless network; and
streaming the requested content to the client device via the wireless network for playback on the client device.

11. The method of claim 10, further comprising providing an indication of available content to the client device based on an application program interface (API) corresponding to the content provider that provided the content.

12. The method of claim 10, wherein the client device comprises a first client device and the requested content comprise first requested content, the method further comprising:
receiving a request for second content (second requested content) different than the first requested content from a second client device connected to the wireless network; and
streaming the second requested content to the second client device via the wireless network for playback on the second client device.

13. The method of claim 10, further comprising redirecting web browser traffic of one or more client devices connected to the wireless network to a web page for managing or viewing stored content on the portable media server, the web page served by the portable media server.

14. The method of claim 10, further comprising selecting an interface or API based on the request or a source of the requested content, wherein streaming the content comprises streaming using the selected interface or API.

15. The method of claim 1, further comprising:
connecting to a remote Internet content provider;
authenticating with the remote Internet content provider;
downloading and storing content from the remote Internet content provider based on restrictions provided by the remote Internet content provider; and
prohibiting copying of files from the storage device to another device or storage location.

16. Non-transitory computer readable storage media storing instructions that, when executed by one or more processors, cause the one or more processors to:
store one or more media content files for video playback;
provide a wireless network for communicating with one or more proximal client devices using a radio;
receive a request for content (requested content) from a client device connected to the wireless network; and
stream the requested content to the client device via the wireless network for playback on the client device.

17. The computer readable storage media of claim 16, wherein the instructions further cause the one or more processors to provide an indication of available content to the client device based on an application program interface (API) corresponding to the content provider that provided the content.

18. The computer readable storage media of claim 16, wherein the client device comprises a first client device and the requested content comprise first requested content, wherein the instructions further cause the one or more processors to:
receive a request for second content (second requested content) different than the first requested content from the second client device connected to the wireless network; and
stream the second requested content to the second client device via the wireless network for playback on the second client device.

19. The computer readable storage media of claim 16, wherein the instructions further cause the one or more processors to one or more of:
redirect web browser traffic of one or more client devices connected to the wireless network to a web page for managing or viewing stored content; or
select an interface or API based on the request or a source of the requested content, wherein streaming the content comprises streaming using the selected interface or API.

20. The computer readable storage media of claim 16, wherein the instructions further cause the one or more processors to:
connect to a remote Internet content provider;
authenticate with the remote Internet content provider;
download and store content from the remote Internet content provider; and
restrict or prohibit copying of files to another device or storage location.
